(19) United States
(12) Patent Application Publication
(10) Pub. No.: US 2025/0095089 A1
(43) Pub. Date: Mar. 20, 2025

(54) SYSTEM FOR FACILITATING THE CREATION OF AN INTELLECTUAL PROPERTY (IP) LICENSE AGREEMENT

(71) Applicants: Viktor Bondarenko, Kyiv (UA); Andrii Bondarenko, Kryvyi Rih (UA); Andrii Ivanov, Kyiv (UA)

(72) Inventors: Viktor Bondarenko, Kyiv (UA); Andrii Bondarenko, Kryvyi Rih (UA); Andrii Ivanov, Kyiv (UA)

(21) Appl. No.: 18/591,002

(22) Filed: Feb. 29, 2024

Related U.S. Application Data
(60) Provisional application No. 63/582,857, filed on Sep. 15, 2023.

(51) Int. Cl. G06Q 50/18; G06Q 30/0601; H04L 9/00; H04L 9/32

(52) U.S. Cl. CPC G06Q 50/184; G06Q 30/0601; H04L 9/3247; H04L 9/50

(57) ABSTRACT

A system for facilitating the creation of an Intellectual Property (IP) license agreement associated with an IP token, the system comprising a server with one or more processors is configured to create a first IP license agreement template, allow a first user to purchase a first IP token, wherein the first IP token is associated with a first IP Owner. Further, authenticate the first user using details associated with a first user crypto-wallet, verify the presence of the first IP token in the first user crypto-wallet, receive first set of information from the first user, and create a Ready-to-Sign (RtS) first IP license agreement based on the first IP license agreement template, a first IP token metadata, and the first set of information. Finally, receive signatures of the first IP Owner and the first user and enforce a first IP license agreement.

### FIELD OF THE INVENTION

This application relates generally to the field of licensing agreements, and more particularly, to a novel approach for licensing an Intellectual Property (IP) along with structuring usage terms, establishing, and enforcing the licensing agreement for a licensor and a licensee.

### BRIEF STATEMENT OF THE PRIOR ART

Intellectual Property (IP) proprietors have the authority to authorize individuals or entities to use content under license-gated conditions. These authorizations are dictated by specific terms and conditions detailed in License Agreements, which are entered into by an IP owner (licensor) or their representatives and the licensees. Licensees can integrate the IP into a product or project within the permissible application areas or, if the License Agreement permits, they can directly sell the IP to other companies or consumers.

Several challenges arise when relying solely on traditional license agreements to enforce terms and conditions related to IP usage. The conventional approach to licensing, via License Agreements, demands substantial effort, time, and expenses from both the IP owner and the licensee. Negotiations on terms, pricing, and the contractual process are particularly time-consuming. In practice, the duration from negotiation to the signing of a License Agreement spans weeks and involves significant legal support costs.

Furthermore, in cases of Licensee non-compliance with the terms of the License Agreement, the process of invoking the License call-off can be intricate and time-intensive. The IP owner may also need to restrict the number of licensees, usage duration, and the application areas of license-gated content. However, administering such limitations would be challenging if reliant solely on traditional agreements.

Therefore, there is a need for an innovative approach that leverages blockchain network to enable licensing of IP's.

### SUMMARY OF THE INVENTION

In an embodiment, a system for facilitating the creation of an intellectual property (IP) license agreement associated with an IP token is disclosed. The system comprising a server with one or more processors is configured to create a first IP license agreement template, enable a first user to purchase a first IP token, wherein the first IP token is associated with a first IP Owner. Further, the server is configured to authenticate the first user using details associated with a first user crypto-wallet, verify the presence of the first IP token in the first user crypto-wallet using a first IP token metadata, receive first set of information from the first user, and create a Ready-to-Sign (RtS) first IP license agreement based on the first IP license agreement template, the first IP token metadata, and the first set of information. Finally, the server is configured to receive digital signatures of the first IP Owner and the first user on the RtS first IP license agreement and enforce a first IP license agreement, wherein duly signed RtS first IP license agreement is considered the first IP license agreement.

### BRIEF DESCRIPTION OF DRAWINGS

Embodiments are illustrated by way of example and not limitation in the figures of the accompanying drawings, in which like references indicate similar elements and in which:

FIG. 1 illustrates a system 100 for enabling licensing of an Intellectual Property (IP), in accordance with an embodiment.

FIG. 2 is a block diagram illustrating a first IP Owner processing system 102, in accordance with an embodiment.

FIG. 3 is a block diagram illustrating architecture of a server 116, in accordance with an embodiment.

FIG. 4 is a block diagram illustrating architecture of a Licensing Control Module (LCM) 120, in accordance with an embodiment.

FIG. 5 is a flowchart 500 illustrating steps involved in generating a first IP token, in accordance with an embodiment.

FIG. 6 is a flowchart 600 illustrating steps involved in transferring the first IP token upon purchase of the first IP token by a second user 112, in accordance with an embodiment.

FIG. 7 is a flowchart 700 illustrating steps involved in transferring the first IP token to the second user 112 when a first IP token status is set as Expired, in accordance with an embodiment.

FIG. 8 is a flowchart 800 illustrating steps involved in creation of a first IP license agreement between a first IP Owner 104 and a first user 108 upon purchase of the first IP token, in accordance with an embodiment.

FIG. 9 is a flowchart 900 illustrating steps involved in restricting the usage of the first IP token upon passing of an expiration date, in accordance with an embodiment.

FIG. 10 is a flowchart 1000 illustrating steps involved in revoking of the first IP token by the first IP Owner 104, in accordance with an embodiment.

FIG. 11 is a flowchart 1100 illustrating steps involved in burning of the first IP token by the first IP Owner 104, in accordance with an embodiment.

FIG. 12 is a flowchart 1200 illustrating steps involved in transfer of the first IP token without commencing a usage countdown, in accordance with an embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

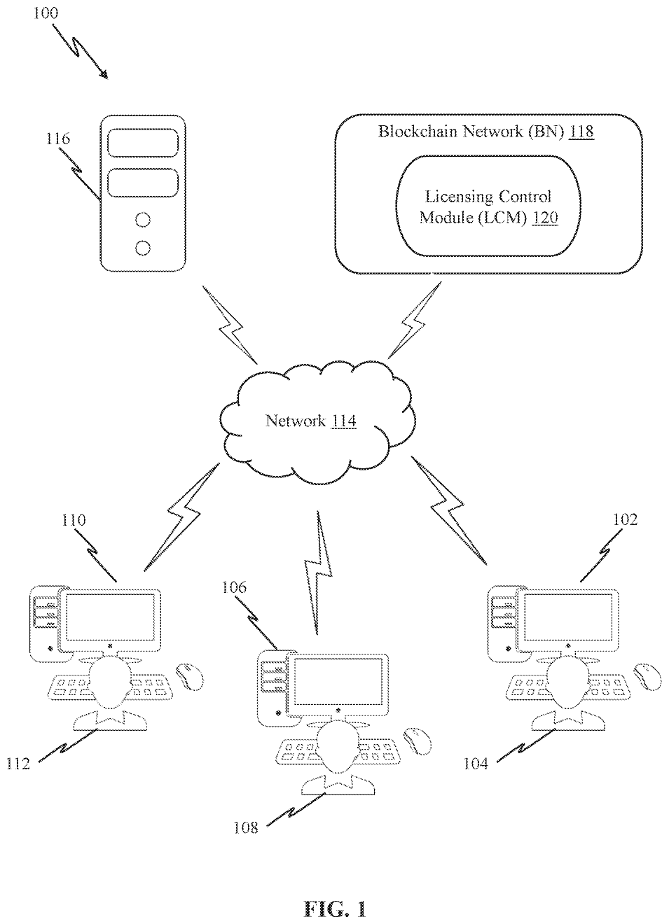

FIG. 1 illustrates a system 100 for enabling licensing of an Intellectual Property (IP), in accordance with an embodiment. The system 100 may comprise of a first Intellectual Property (IP) Owner processing system 102, a first user processing system 106, a second user processing system 110, a network 114, a server 116, and a Blockchain Network (BN) 118. The first IP Owner processing system 102 may be associated with a first IP Owner 104. The first user processing system 106 and the second user processing system 110 may be associated with a first user 108 and a second user 112, respectively. The server 110 may be configured to establish and coordinate a secured connection between the first IP Owner processing system 102, the first user processing system 106, the second user processing system 110, and the BN 118. The first IP Owner processing system 102, the first user processing system 106, the second user processing system 110, the BN 118, and the server 116 may further be connected via the network 114, wherein the network 114 enables communication between them. The network 114 may be, but not limited to, a local area network, wide area network or a metropolitan area network.

In an embodiment, the BN 118 may comprise of Licensing Control Module (LCM) 120. The LCM 120 may be configured to enable licensing of the IP. The LCM 120 is explained in greater detail in further sections of this document.

In another embodiment, the system 100 may comprise a second IP Owner processing system, a third IP Owner processing system, and so on, wherein the second IP Owner processing system may be associated with a second IP Owner, the third IP Owner processing system may be associated with a third IP Owner, and so on (not shown in the figures).

In another embodiment, the system 100 may comprise a third user processing system, a fourth user processing system, and so on, wherein the third user processing system may be associated with a third user, the fourth user processing system may be associated with a fourth user, and so on (not shown in the figures).

In an embodiment, a first IP may be associated with the first IP owner 104, wherein the first IP may represent an IP in a digital form. The first IP may be, but not limited to, drawings, paintings, music, film, poetry, books, and legal documents (for example: a patent document, a copyright associated with a creative content, or a trademark) represented in a digital form.

In an embodiment, the term “first IP Owner 104” may additionally encompass a user or legal entity acting on behalf of the first IP Owner 104.

In an embodiment, the first IP Owner 104, upon signing of an IP license agreement, may be referred to as a first licensor.

In an embodiment, the first user 108 and the second user 112 may be users intending to purchase or request a transfer of the first IP from the first IP Owner 104. Upon completion of the purchase and signing of the IP license agreement, the first user 108 and the second user 112 may be referred as a first licensee and a second licensee, respectively.

In an embodiment, a first IP Owner crypto-wallet may be associated with the first IP Owner 104, a first user crypto-wallet may be associated with the first user 108, a first licensee crypto-wallet may be associated with the first licensee, a second user crypto-wallet may be associated with second user 112, and a second licensee crypto-wallet may be associated with the second licensee. It may be noted based on the aforementioned that the first user crypto-wallet may be considered to be the first licensee crypto-wallet upon receiving the first IP token and signing of the IP license agreement. Similarly, the second user crypto-wallet may be considered to be the second licensee crypto-wallet upon receiving the first IP token and signing of the IP license agreement.

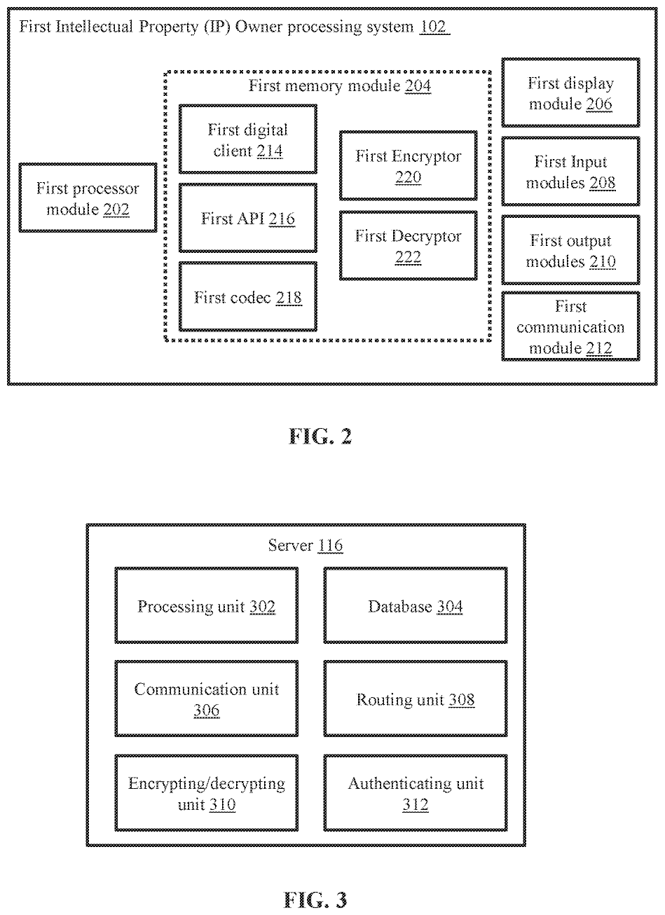

FIG. 2 is a block diagram illustrating the first IP Owner processing system 102, in accordance with an embodiment. The first IP Owner processing system 102 may comprise of, but not limited to, a first processor module 202, a first memory module 204, a first display module 206, first input modules 208, first output modules 210 and a first communication module 212.

The first processor module 202 may be implemented in the form of one or more processors and may be implemented as appropriate in hardware, computer-executable instructions, firmware, or combinations thereof. Computer-executable instruction or firmware implementations of the first processor module 202 may include computer-executable or machine-executable instructions written in any suitable programming language to perform the various functions described.

The first memory module 204 may include a permanent memory such as hard disk drive, may be configured to store data, and executable program instructions that are implemented by the processor module. The first memory module 204 may be implemented in the form of a primary and a secondary memory. The first memory module 204 may store additional data and program instructions that are loadable and executable on the first processor module 202, as well as data generated during the execution of these programs. Further, the first memory module 204 may be a volatile memory, such as random-access memory and/or a disk drive, or a non-volatile memory. The first memory module 204 may comprise of removable memory such as a Compact Flash card, Memory Stick, Smart Media, Multimedia Card, Secure Digital memory, or any other memory storage that exists currently or may exist in the future.

In an embodiment, the first memory module 204 may further comprise a first digital client 214, a first Application Programming Interface (API) 216, a first codec 218, a first encryptor 220 and a first decryptor 222. The first digital client 214 may be a web browser or a software application that enables video conferencing, wherein the first digital client 214 may further comprise a first digital client display interface. The first digital client display interface may enable the interaction of the first licensor 104 with the first licensor processing system 102. The first codec 218 may include computer-executable or machine-executable instructions written in any suitable programming language to compress outgoing data and decompress incoming data. The first encryptor 220 may encrypt the data being sent and the first decryptor 222 may decrypt any encrypted incoming data.

The first display module 206 may display an image, a video, or data to a user. For example, the first display module 206 may include a panel, and the panel may be an LCD, LED or an AM-OLED.

The first input modules 208 may provide an interface for input devices such as keypad, touch screen, mouse, and stylus among other input devices. In an embodiment, the first input module 208 includes a camera and a microphone.

The first output modules 210 may provide an interface for output devices such as display screen, speakers, printer, and haptic feedback devices, among other output devices.

The first communication module 212 may be used by the first data processing system 102 to communicate with the server 110. The first communication module 212, as an example, may be a GPRS module, or other modules that enable wireless communication.

It may be noted that the first user processing system 106 and the second user processing system 110, may have a similar architecture as that of the first IP Owner processing system 102, and is therefore the details are not repeated for the sake of brevity.

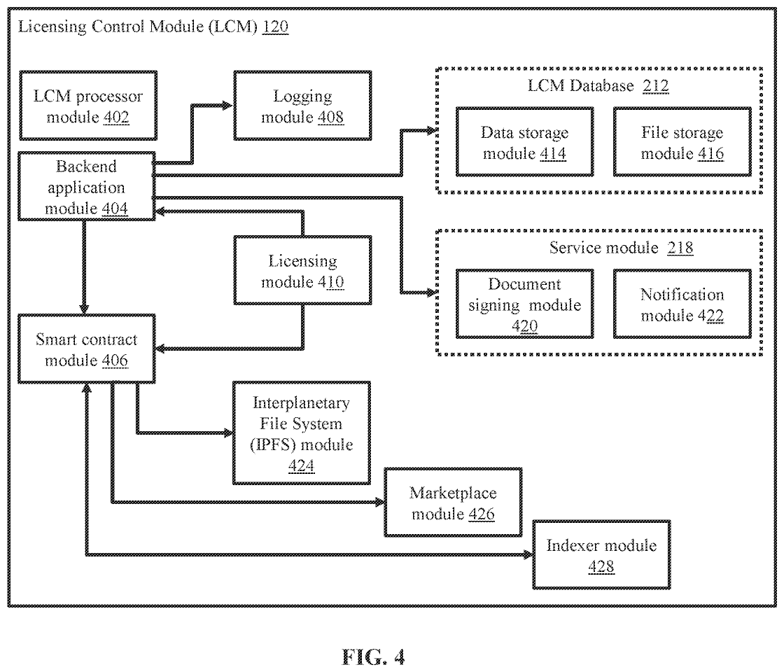

FIG. 3 is a block diagram illustrating architecture of the server 116, in accordance with an embodiment. The server 116 may comprise a processing unit 302, a database 304, a communication unit 306, a routing unit 308, an encrypting/decrypting unit 310, and an authenticating unit 312.

The processing unit 302 may be implemented in the form of one or more processors and may be implemented as appropriate in hardware, computer-executable instructions, firmware, or combinations thereof. Computer-executable instruction or firmware implementations of the processing unit 302 may include computer-executable or machine-executable instructions written in any suitable programming language to perform the various functions described.

The database 304 may include a permanent memory such as hard disk drive, that may be configured to store data, and executable program instructions that are implemented by the processor module.

The communication unit 306 may be used by the server 116 to communicate with the first IP Owner processing system 102, the first user processing system 106, and the second user processing system 110. The communication unit 306, as an example, may be, but not limited to, a GPRS module, or other modules that enable wireless communication.

The routing unit 308 may be configured to enable identification of licensor/licensee processing systems to which the data must be transmitted.

The encrypting/decrypting unit 310 may be configured to decrypt any encrypted incoming data from each of the data processing systems and encrypt the outgoing data from the server 116.

The authenticating module 312 may be configured to authenticate each of the plurality of licensor's and plurality of licensee's associated with each of the licensor processing systems and licensee processing systems, respectively, before establishing a connection.

FIG. 4 is a block diagram illustrating architecture of the LCM 120, in accordance with an embodiment. The LCM 120 may comprise of a LCM processor module 402, a backend application module 404, a smart contract module 406, a logging module 408, a licensing module 410, a LCM database 412, a service module 418, an Interplanetary File System (IPFS) module 424, a marketplace module 426, and an indexer module 428. The LCM database 412 may further comprise of a data storage module 414 and a file storage module 416. The service module 418 may further comprise of a document signing module 420 and a notification module 422.

In an embodiment, the LCM processor module 402 may be implemented in the form of one or more processors and may be implemented as appropriate in hardware, computer-executable instructions, firmware, or combinations thereof. Computer-executable instruction or firmware implementations of the LCM processor module 402 may include computer-executable or machine-executable instructions written in any suitable programming language to perform the various functions described.

In an embodiment, the LCM 120 may be configured to, upon receiving instructions from the server 116, to generate (mint) a first IP token based on the first IP, wherein minting of the first IP token may refer to creation of a Non-Fungible Token (NFT). Further, minting of the first IP token may include, but not limited to, creation of the first IP token identifier, creation of first IP token ownership tracker, and creation of first IP token transfer tracker.

In an embodiment, the LCM 120 may be configured to, upon receiving instructions from the server 116, to burn the first IP token, wherein burning the first IP token may refer to transfer of the first IP token to an inaccessible crypto-address, wherein the inaccessible crypto-address is an address that no one has access to.

In an embodiment, the backend application module 404 may be configured to serve as a source of a first IP token metadata information. Further, the backend application module 404 may be configured to, but not limited to, fragment and structure terms and conditions of usage for the first IP, enable access to the first IP and the first IP token, verify ownership of the first IP token, and create IP license agreement templates.

In an embodiment, the backend application module 404 may further be configured to set/update a first IP token status, wherein the first IP token status may comprise of statuses namely Available, In-Use, and Expired. The first IP token metadata may include, but not limited to, a usage duration set for the usage of the said first IP token, wherein the backend application module 404 may be configured to receive the usage duration of the first IP token from the first IP Owner 104.

In an embodiment, the status Available may mean that the IP token is available for purchase to the first user 108 and the second user 112. The status In-Use may mean that the IP token is already purchased, a usage countdown has started, and/or an expiration date of the IP token is not yet reached. Further, the status Expired may represent that the IP token has expired (i.e., the expiration date has passed or the usage countdown has ended) and is restricted to be used by the first user 108 and/or the second user 112.

In an embodiment, when the first IP token status is set as Available, the LCM 120 may be configured to enable the first IP owner 104 to sell the first IP token. When the first IP token status is set as In-Use, the LCM 120 may be configured to enable the first licensor to burn the first IP token. Finally, when the first IP token status is set as Expired, the LCM 120 may be configured to enable the first IP owner 104 or the first licensor to retrieve the first IP token to the first IP Owner crypto-wallet.

In an embodiment, when the first IP token status is set as Available, the LCM 120 may be configured to enable the first user 108 and/or the second user 112 to buy the first IP token. When the first IP token status is set as In-Use, the LCM 120 may be configured to enable the first user 108 and/or the second user 112 to sign a first IP license agreement and a second IP license agreement, respectively. Further, the LCM 120 may be configured to enable the first licensee and/or the second licensee to sell the first IP token. Further, the LCM 120 may be configured to enable the first licensee and/or the second licensee to conclude the IP license agreement. Finally, when the first IP token status is set as Expired, the LCM 120 may be configured to restrict the first licensee and/or the second licensee from transferring the first IP token.

In an embodiment, the first licensee and the second licensee may be allowed to sell plurality of IP tokens.

In an embodiment, the backend application module 404 may be configured to generate visuals and metadata from the received first IP.

In an embodiment, the data storage module 414 may be configured to store data such as, but not limited to, events associated with the first IP token, licensor and licensee authentication data, and/or scheduled jobs, wherein scheduled jobs may include instructions received from the first licensor, the first licensee, and/or the second licensee.

In an embodiment, the file storage module 416 may be configured to store data such as, but not limited to, the IP license agreement templates, the first IP token and the first IP token metadata information.

In an embodiment, the logging module 408 may be configured to store the first IP token status.

In an embodiment, the licensing module 410 may be configured to provide a user interface to the first IP Owner 104, wherein the first IP Owner 104 may set the terms and conditions associated with the first IP token. Further, the licensing module 410 may be configured to retrieve the terms and conditions associated with the first IP token, when requested by the server 116.

In an embodiment, the licensing module 410 may be configured to authenticate the first IP Owner 104, the first user 108, and the second user 112. The licensing module 410 may be configured to authenticate the first user 108 using the details associated with a first user crypto-wallet and verify the presence of the first IP token in the first user crypto-wallet using the first IP token metadata.

In an embodiment, the document signing module 420 may be configured to allow the first IP Owner 104, and the first user 108 and/or the second user 112 to sign the IP license agreement created for the purchase of the first IP token. Further, the notification module 422 may be configured to notify the first IP Owner 104, and the first user 108 and/or the second user 112 regarding the completion of signing of the IP license agreement. The notification module 422 may be configured to notify via means of, but not limited to, a phone call, an Email, or a text message.

In an embodiment, the smart contract module 406 may be configured to enforce the IP license agreement associated with the first IP token. The licensing module 410 may be configured to communicate with the backend application module 404 and the smart contract module 406.

In an embodiment, the smart contract module 406 may be configured to generate the first IP token. Further, the smart contract module 406 may be configured to store the first IP token metadata and the IP license agreement in the IPFS module 424. The marketplace module 426 may be configured to receive instructions from the smart contract module 406 to enable the first user 108, and or the second user 112 to purchase the first IP token from a marketplace. The Indexer module 428 may be configured to access and display data stored on a blockchain ledger associated with the BN 118. Further, the indexer module 428 may be allowed to write/store events associated with the first IP token, on the blockchain ledger.

In an embodiment, the marketplace may refer to, but not limited to, an online website, and/or an offline store, wherein the marketplace may enable, but not limited to, listing of the first IP token and purchase of the first IP token.

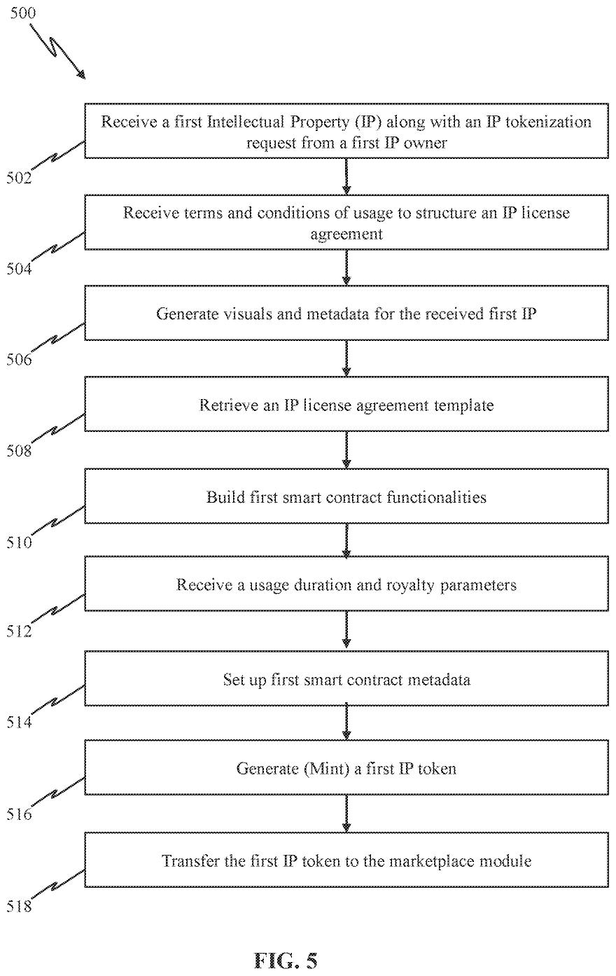

FIG. 5 is a flowchart 500 illustrating steps involved in generating the first IP token, in accordance with an embodiment. At step 502, the server 116 may be configured to receive an IP tokenization request along with the first IP from the first IP Owner 104.

At step 504, the server 116 may be configured to receive terms and conditions of usage of the first IP from the first IP Owner 104, wherein the terms and conditions of usage are utilized to structure an IP license agreement.

At step 506, the server 116 may be configured to generate visuals and metadata from the received first IP.

At step 508, the server 116 may be configured to retrieve an IP license agreement template, wherein the received terms and conditions of usage are incorporated in to the IP license agreement template.

At step 510, the server 116 may be configured to instruct the smart contract module 406 to create first smart contract functionalities and associate with the IP license agreement template.

At step 512, the server 116 may be configured to receive the usage duration and IP token royalty parameters. The IP token duration may be the duration of the first IP token until which a licensee may be allowed to use the first IP token, following which the first IP token status associated with the first IP token is updated to Expired. The IP token royalty parameters may determine the royalties received by the first IP Owner 104, when the first IP token is In-Use.

At step 514, the server 116 may be configured to retrieve the first IP token metadata and setup a first smart contract metadata.

At step 516, the server 116 may be configured to generate (mint) the first IP token using the first IP.

In an embodiment, the first IP token may be associated with the IP license agreement template.

At step 518, the server 116 may be configured to transfer the first IP token to the marketplace module 426.

In an embodiment, the server 116 may be configured to instruct the marketplace module 426 to enable the first user 108, and/or the second user 112 to purchase the first IP token from the marketplace.

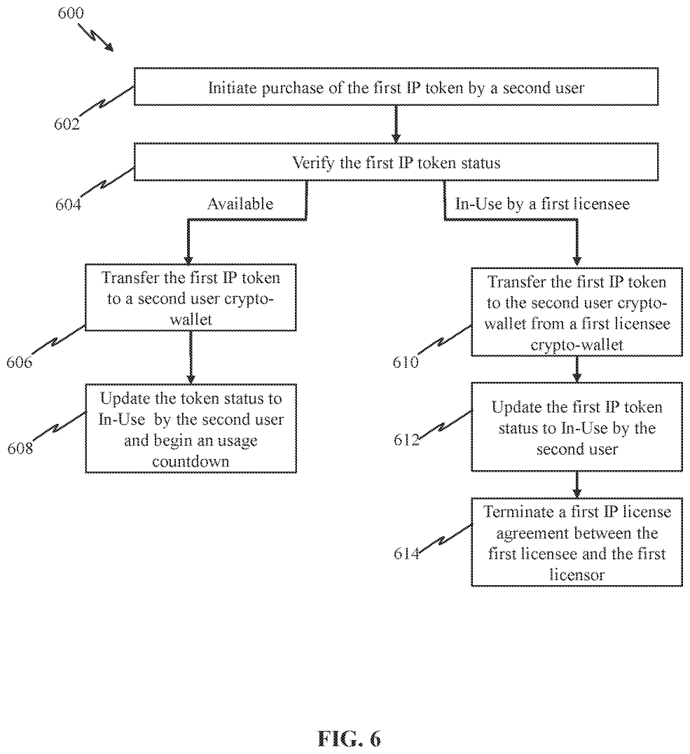

FIG. 6 is a flowchart 600 illustrating steps involved in transferring the first IP token upon purchase of the first IP token by the second user 112, in accordance with an embodiment. At step 602, the second user 112 initiates purchase of the first IP token through the server 116.

At step 604, the server 116 may be configured to verify the first IP token status.

When the first IP token status is determined to be set as Available, at step 606, the server 116 may be configured to transfer the first IP token to the second user crypto-wallet.

At step 608, the server 116 may be configured to update the first IP token status to In-Use by the second user 112 and begin the usage countdown.

When the first IP token status is determined to be set as In-Use, wherein the first licensee is using the first IP token and has signed a first IP license agreement with the first IP Owner 104, at step 610, the server 116 may be configured to transfer the first IP token to the second user crypto-wallet from the first licensee crypto-wallet.

At step 612, the server 116 may be configured to update the first IP token status to In-Use by the second user 112.

In an embodiment, the usage countdown may continue from the time and date of receiving the first IP token by the first user 108.

In another embodiment, the usage countdown may start upon updating the first IP token status to In-Use by the second user 112.

At step 614, the server 116 may be configured to terminate the first IP license agreement between the first licensee and the first licensor.

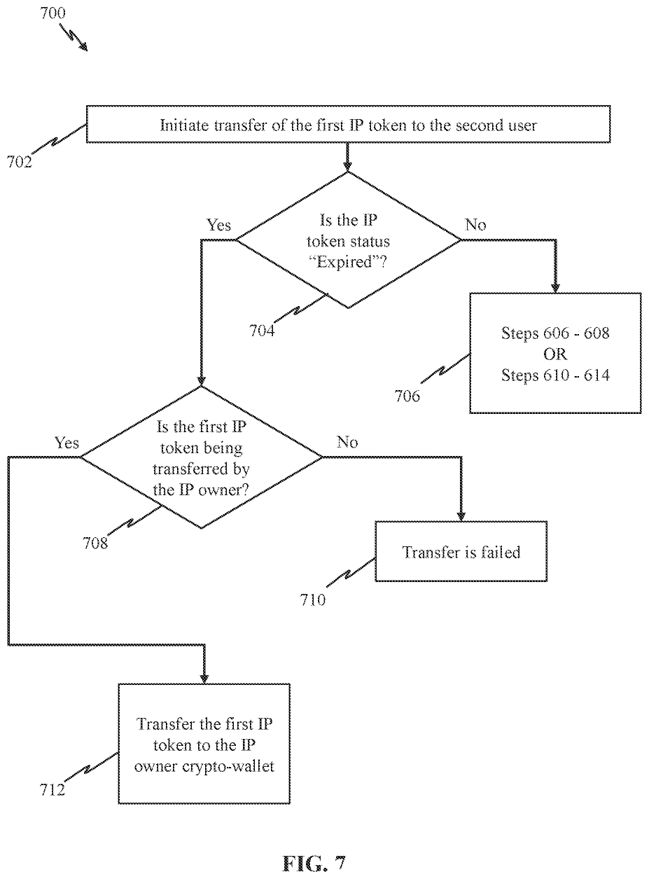

FIG. 7 is a flowchart 700 illustrating steps involved in transferring the first IP token to the second user 112 when the first IP token status is determined to be set as Expired, in accordance with an embodiment. At step 702, the server 116 may be configured to initiate transfer of the first IP token to the second user 118.

At step 704, the server 116 may be configured to verify the status of the first IP token.

At step 706, when the first IP token status is determined to be set as Available, steps 606-608 (discussed while explaining FIG. 6 in the previous paragraphs) are executed. Additionally, when the first IP token status is determined to be set as In-Use, steps 610-614 (discussed while explaining FIG. 6 in the previous paragraphs) are executed.

When the first IP token status is determined to be set as Expired, at step 708, the server 116 may be configured to verify if the first IP token is being transferred by the first IP owner 104.

Upon verification, if the first IP token is not being transferred by the first IP Owner 104, at step 710, the server 116 may be configured to notify the first IP owner 104 that the transfer has failed.

Upon verification, if the first IP token is being transferred by the first IP Owner 104, at step 712, the server 116 may be configured to transfer the first IP token to the IP Owner crypto-wallet.

FIG. 8 is a flowchart 800 illustrating steps involved in creation of the first IP license agreement between the first IP Owner 104 and the first user 108 upon purchase of the first IP token, in accordance with an embodiment. At step 802, the server 116 may be configured to receive consent for a first IP license agreement template from the first user 108.

At step 804, the server 116 may be configured to enable the first user 108 to purchase the first IP token.

It may be noted that, upon enabling the first user 108 to purchase the first IP token, the steps 602-608 or steps 602-604 and 610-614 may be executed.

At step 806, the server 116 may be configured to instruct the licensing module 410 to receive consent for the terms and conditions of usage of the first IP token.

At step 808, the server 116 may be configured to authenticate the first user 108 upon receiving details associated with the first user crypto-wallet.

At step 810, the server 116 may be configured to verify the presence of the first IP token, in the first user crypto-wallet, with first IP token metadata.

At step 812, the server 116 may be configured to receive first set of information from the first user 108, wherein the first set of information may be a set of legal details. The set of legal details may include information such as, but not limited to, name, address, geographic location of the first licensee, and so on.

At step 814, the server 116 may be configured to instruct the backend application module 404 to create a Ready-to-Sign (RtS) first IP license agreement template based on the first IP license agreement template, first set of information, and the first IP token metadata.

At step 816, the server 116 may be configured to instruct the document signing module 420 to receive digital signatures from the first IP owner 104 and the first user 108 on the RtS first IP license agreement template.

At step 816, the server 116 may be configured to enforce the first IP license agreement, wherein signed RtS first IP license agreement template is recognized as the first IP license agreement. Following the conclusion of step 816, the designation of the first user 108 may be transitioned to that of the first licensee and the designation of the first IP Owner 104 may be transitioned to that of the first licensor.

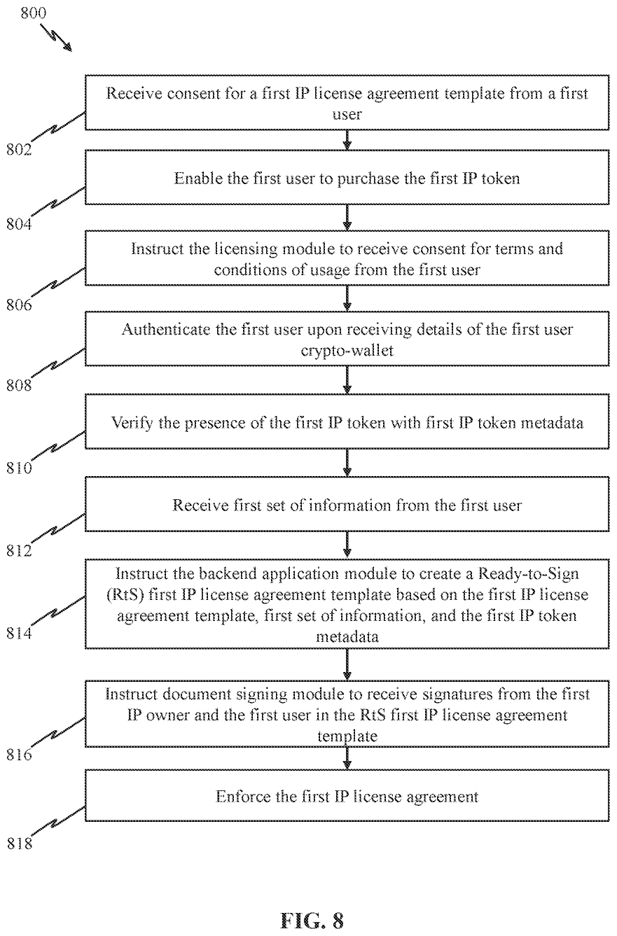

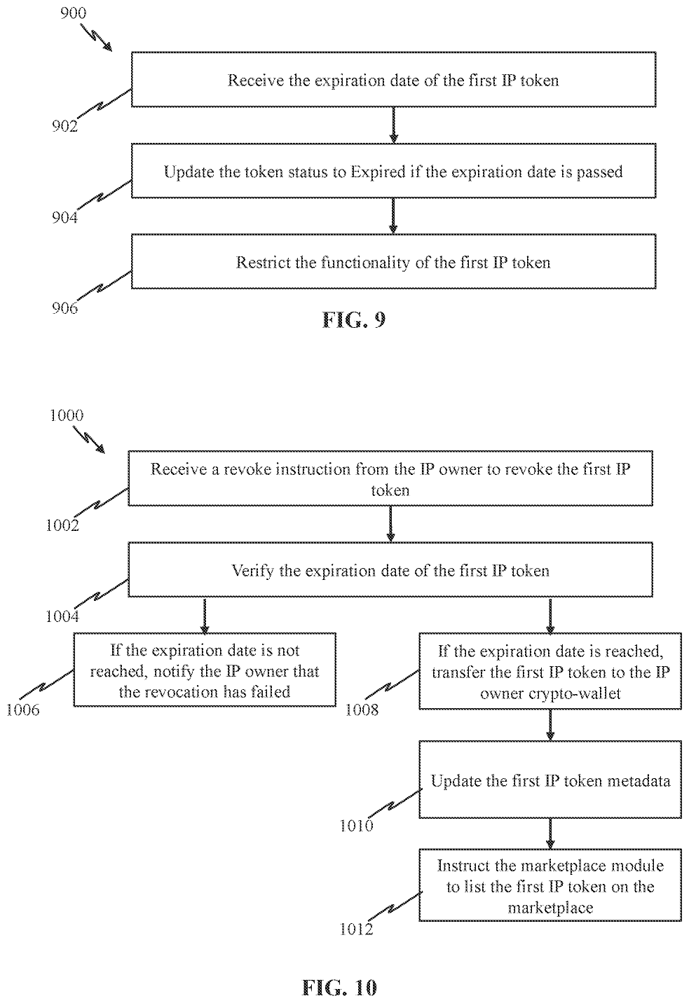

FIG. 9 is a flowchart 900 illustrating steps involved in restricting the usage of the first IP token upon passing of the expiration date, in accordance with an embodiment. At step 902, the server 116 may be configured to receive the expiration date of the first IP token.

In an embodiment, the server 116 may be configured to periodically receive the expiration dates associated with plurality of IP tokens.

At step 904, the server 116 may be configured to update the first IP token status to Expired when the expiration date is passed.

At step 906, the server 116 may restrict the functionality of the first IP token.

In an embodiment, the server 116 may automatically transfer the first IP token from the first licensee crypto-wallet to the first IP Owner crypto-wallet upon passing the expiration date.

In an embodiment, the server 116 may be configured to automatically terminate the first IP license agreement upon transferring the first IP token from the first licensee crypto-wallet to the first IP Owner crypto-wallet.

In an embodiment, the server 116 may be configured to, upon receiving an instruction to burn the first IP token, burn the first IP token and automatically terminate the first IP license agreement.

FIG. 10 is a flowchart 1000 illustrating steps involved in revoking of the first IP token by the first IP Owner 104, in accordance with an embodiment. At step 1002, the server 116 may be configured to receive a revoke instruction from the first IP Owner 104 to revoke the first IP token.

At step 1004, the server 116 may be configured to verify the expiration date of the first IP token.

If the expiration date is not reached, at step 1006, the server 116 may be configured to instruct the notification module 422 to notify the first IP Owner 104 that the revocation has failed.

If the expiration date is reached, at step 1008, the server 116 may be configured to transfer the first IP token to the IP Owner crypto-wallet.

At step 1010, the server 116 may be configured to update the first IP token metadata.

At step 1012, the server 116 may be configured to instruct the marketplace module 426 to list the first IP token on the marketplace.

In an embodiment, the server 116 may be configured to receive a Burn request from the first IP Owner 104, wherein the Burn request may include instructions such as, but not limited to, burn the first IP token upon passing of expiration date, burn the first IP token on a specific date regardless of the expiration date, or burn the first IP token upon breach of the first IP license agreement by either the first licensor 104 or the first licensee.

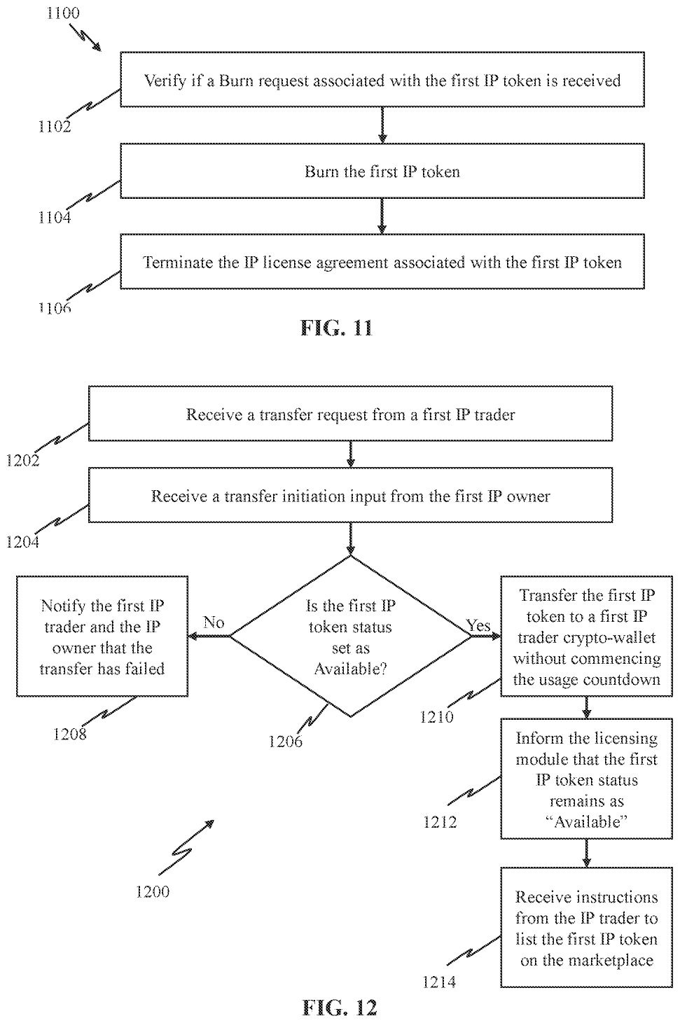

FIG. 11 is a flowchart 1100 illustrating steps involved in burning of the first IP token by the first IP Owner 104, in accordance with an embodiment. At step 1102, the server 116 may be configured to receive the Burn request associated with the first IP token.

In an embodiment, the server 116 may be configured to retrieve a burn date, wherein the burn date may be after the expiration date. Further, the server 116 may be configured to burn the first IP token upon passing the burn date.

In an embodiment, the server 116 may be configured to burn the first IP token upon detecting a violation of the IP license agreement by the first licensee.

At step 1104, the server 116 may be configured to burn the first IP token.

In an embodiment, the server 116 may be configured to burn the first IP token with the consent of the first IP Owner 104.

At step 1106, the server 116 may be configured to terminate the IP license agreement associated with the first IP token upon burning of the first IP token.

In an embodiment, a first IP Trader may be a user who trades the first IP token on behalf of the first IP Owner 104. A first IP trader processing system may be associated with a first IP Trader. Further, a first IP Trader crypto-wallet may be associated with the first IP Trader.

FIG. 12 is a flowchart 1200 illustrating steps involved in transfer of the first IP token without commencing the usage countdown, in accordance with an embodiment. At step 1202, the server 116 may be configured to receive a transfer request from the first Trader.

At step 1204, the server 116 may be configured to receive a transfer initiation input from the first IP owner 104.

At step 1206, the server 116 may be configured to retrieve the first IP token status and determine if the first IP token status is set as Available. If the first IP token status is other than Available, at step 1208, the server 116 may notify the first IP Trader and the first IP Owner that the transfer has failed.

If the first IP token status is Available, at step 1210, the server 116 may be configured to transfer the first IP token to the first IP Trader crypto-wallet.

In one embodiment, the usage countdown does not commence upon the transfer of the first IP token to the first IP Trader crypto-wallet.

At step 1212, the server 116 may be configured to inform the licensing module 410 that the first IP token status remains as Available.

At step 1214, the server 116 may be configured to receive instructions from the first IP Trader to list the first IP token on the marketplace.

After the execution of step 1214, when the first user 108 or the second user 112 intend to purchase the first IP token from the first IP trader, processes described in the foregoing are repeated as required.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and process or method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for facilitating the creation of an intellectual property (IP) license agreement associated with an IP token, the system comprising a server with one or more processors is configured to:
create a first IP license agreement template;
enable a first user to purchase a first IP token, wherein the first IP token is associated with a first IP Owner;
authenticate the first user using details associated with a first user crypto-wallet;
verify the presence of the first IP token in the first user crypto-wallet using a first IP token metadata;
receive first set of information from the first user;
create a Ready-to-Sign (RtS) first IP license agreement based on the first IP license agreement template, the first IP token metadata, and the first set of information;
request and receive digital signatures of the first IP Owner and the first user on the RtS first IP license agreement; and
enforce a first IP license agreement, wherein duly signed RtS first IP license agreement is considered the first IP license agreement.

2. The system according to claim 1, wherein the system comprises a Licensing Control Module (LCM), wherein the LCM comprises of:
a backend application module configured to:
create the first IP license agreement template; and
create the RtS first IP license agreement;
a licensing module configured to:
authenticate the first user, using details associated with the first user crypto-wallet;
verify the presence of the first IP token in the first user crypto-wallet using the first IP token metadata; and
receive from the first user the first set of information;
a marketplace module configured to enable the first user to buy the first IP token,
wherein the first IP token is associated with the first IP Owner;
a document signing module configured to receive digital signatures of the first IP Owner and the first user on the RtS first IP license agreement; and
a smart contract module configured to enforce the first IP license agreement, wherein duly signed RtS first IP license agreement is considered the first IP license agreement.

3. The system according to claim 2, wherein the backend application module is configured to:
store the first IP license agreement template in a file storage module; and
retrieve the first IP license agreement template form the file storage module.

4. The system according to claim 1, wherein the server is configured to:
receive a first Intellectual Property (IP) along with an IP tokenization request from the first IP owner;
receive terms and conditions of usage from the first IP Owner;
generate visuals and metadata for the received first IP;
retrieve an IP license agreement template;
create first smart contract functionalities for the first IP;
receive a usage duration and royalty parameters from the first IP Owner;
setup a first smart contract metadata;
generate the first IP token; and
transfer the generated first IP token to a marketplace via the marketplace module, wherein the marketplace module is configured to enable the first user to purchase the generated first IP token that is transferred to the marketplace.

5. The system according to claim 1, wherein the server is configured to associate a first IP token status to the first IP token, wherein:
when the first IP token status is set as Available:
the first IP Owner is allowed to sell the first IP token; and
the first user is allowed to purchase the first IP token;
when the first IP token status is set as In-Use:
the first IP Owner is allowed to burn the first IP token;
the first user is allowed to sell the first IP token to a second user; and
the first user is allowed to conclude the first IP license agreement; and
when the first IP token status is set as Expired:
the first IP Owner is allowed to retrieve the first IP token; and
the first user is restricted from transferring the first IP token.

6. The system according to claim 5, wherein the server, upon receiving an instruction from the first IP Owner and when the first IP token status is set as Expired, is configured to:
retrieve the first IP token to a first IP Owner crypto-wallet; and
update the first IP token status to Available from Expired.

7. The system according to claim 6, wherein when the first user receives the first IP token, the server is configured to set the first IP token status as In-Use and begin a usage countdown.

8. The system according to claim 7, wherein the server is configured to set the first IP token status as Expired when the usage countdown ends.

9. The system according to claim 8, wherein the server, when the usage countdown ends, is configured to:
transfer the first IP token to a first IP Owner crypto-wallet; and
terminate the first IP license agreement.

10. The system according to claim 1, wherein the server is configured to receive a burn request, wherein upon receiving the burn request, the server is configured to:
transfer the first IP token to an inaccessible crypto-address; and
terminate the first IP license agreement.

11. The system according to claim 1, wherein the system is configured to:
transfer the first IP token to a first IP trader from the first IP Owner;
enable the first user to purchases the first IP token from the first IP trader;
request and receive digital signatures from the first IP Owner and the first user on the RtS first IP license agreement upon purchase of the first IP token from the first IP trader; and
begin a usage countdown upon receiving digital signatures from the first IP Owner and the first user on the RtS first IP license agreement.

12. A method for facilitating the creation of an intellectual property (IP) license agreement associated with an IP token, the method comprising the steps of:
creating, by a backend application module, a first IP license agreement template;
enabling, by a marketplace module, a first user to purchase a first IP token, wherein the first IP token is associated with a first IP Owner;
authenticating, by a licensing module, the first user using details associated with a first user crypto-wallet;
verifying, by the licensing module, the presence of the first IP token in the first user crypto-wallet using a first IP token metadata;
receiving, by the licensing module, first set of information from the first user;
creating, by the backend application module, a Ready-to-Sign (RtS) first IP license agreement based on the first IP license agreement template, the first IP token metadata, and the first set of information;
receiving, by a document signing module, digital signatures of the first IP Owner and the first user on the RtS first IP license agreement; and
enforcing, by a smart contract module, a first IP license agreement, wherein duly signed RtS first IP license agreement is considered the first IP license agreement.

13. The method according to claim 12, further comprising the steps of:
receiving a first Intellectual Property (IP) along with an IP tokenization request from the first IP owner;
receiving terms and conditions of usage for the first IP from the first IP Owner;
generating visuals and metadata for the received first IP;
retrieving an IP license agreement template;
creating first smart contract functionalities for the first IP;
receiving a usage duration and royalty parameters for the first IP from the first IP Owner;
setting up a first smart contract metadata;
generating the first IP token; and
transferring the generated first IP token to a marketplace via the marketplace module,
wherein the marketplace module is configured to enable the first user to purchase the generated first IP token that is transferred to the marketplace.

14. The method according to claim 12, further comprising the steps of associating a first IP token status to the first IP token, wherein:
when the first IP token status is set as Available:
the first IP Owner is allowed to sell the first IP token; and
the first user is allowed to purchase the first IP token;
when the first IP token status is set as In-Use:
the first IP Owner is allowed to burn the first IP token;
the first user is allowed to sell the first IP token to a second user; and
the first user is allowed to conclude the first IP license agreement; and
when the first IP token status is set as Expired:
the first IP Owner is allowed to retrieve the first IP token; and
the first user is restricted from transferring the first IP token.

15. The method according to claim 14, upon receiving an instruction from the first IP Owner and when the first IP token status is set as Expired, the method further comprising the steps of:
retrieving the first IP token to a first IP Owner crypto-wallet; and
updating the first IP token status to Available from Expired.

16. The method according to claim 14, when the first user receives the first IP token, the method further comprising the step of setting up the first IP token status as In-Use and starting a usage countdown.

17. The method according to claim 15, the method comprising the step of setting the first IP token status as Expired when the usage countdown ends.

18. The method according to claim 17, when the usage countdown ends, the method comprising the steps of:
transferring the first IP token to a first IP Owner crypto-wallet; and
terminating the first IP license agreement.

19. The method according to claim 12, the method comprising the step of:
receiving a burn request, wherein upon receiving the burn request the server is configured to transfer the first IP token to an inaccessible crypto-address; and
terminating the first IP license agreement.

20. The method according to claim 12, wherein the method comprising the steps of:
transferring the first IP token to a first IP trader from the first IP Owner;
enabling the first user to purchase the first IP token from the first IP trader;
requesting and receiving digital signatures from the first IP Owner and the first user on the RtS first IP license agreement upon purchase of the first IP token from the first IP trader; and
starting a usage countdown upon receiving digital signatures from the first IP Owner and the first user on the RtS first IP license agreement.
